(19) United States
(12) Patent Application Publication
(10) Pub. No.: US 2014/0365788 A1
(43) Pub. Date: Dec. 11, 2014

(54) CONTROL CIRCUIT FOR HARD DISK DRIVES

(71) Applicants: HON HAI PRECISION INDUSTRY CO., LTD., New Taipei (TW); HONG FU JIN PRECISION INDUSTRY (ShenZhen) CO. LTD., Shenzhen (CN)

(72) Inventors: LEI LIU, Shenzhen (CN); GUO-YI CHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/102,471

(22) Filed: Dec. 10, 2013

(30) Foreign Application Priority Data
Jun. 7, 2013 (CN) 2013102243728

(51) Int. Cl. G06F 1/26

(52) U.S. Cl. CPC G06F 1/26
USPC 713/300

(57) ABSTRACT

A control circuit includes a power supply, a measurement unit, a control unit, and hard disk drives. The power supply is used to supply power for the hard disk drives. The measurement unit is used to detect a current of the power supply and output a trigger signal if the current of the power supply is greater than a preset current. The control unit is connected between the measurement unit and the hard disk drives. When the control unit receives the trigger signal, the control unit outputs a control signal to control the hard disk drives to start up in a predetermined order.

### BACKGROUND

1. Technical Field

The present disclosure relates to a circuit for controlling hard disk drives.

2. Description of Related Art

Hard disk drives are used in a server. When the server is started up, all the hard disk drives are started up at the same time, and an inrush current is generated by the hard disk drives. However, the inrush current may be greater than an operation current of the server, which may damage the server.

Therefore, there is room for improvement in the art.

### BRIEF DESCRIPTION OF THE DRAWINGS

Many aspects of the present disclosure can be better understood with reference to the following drawing. The components in the drawing are not necessarily drawn to scale, the emphasis instead being placed upon clearly illustrating the principles of the present disclosure. Moreover, in the drawing, like reference numerals designate corresponding parts throughout the several views.

FIG. 1 is a block diagram of an embodiment of a control circuit.

FIG. 2 is a circuit diagram of the control circuit of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

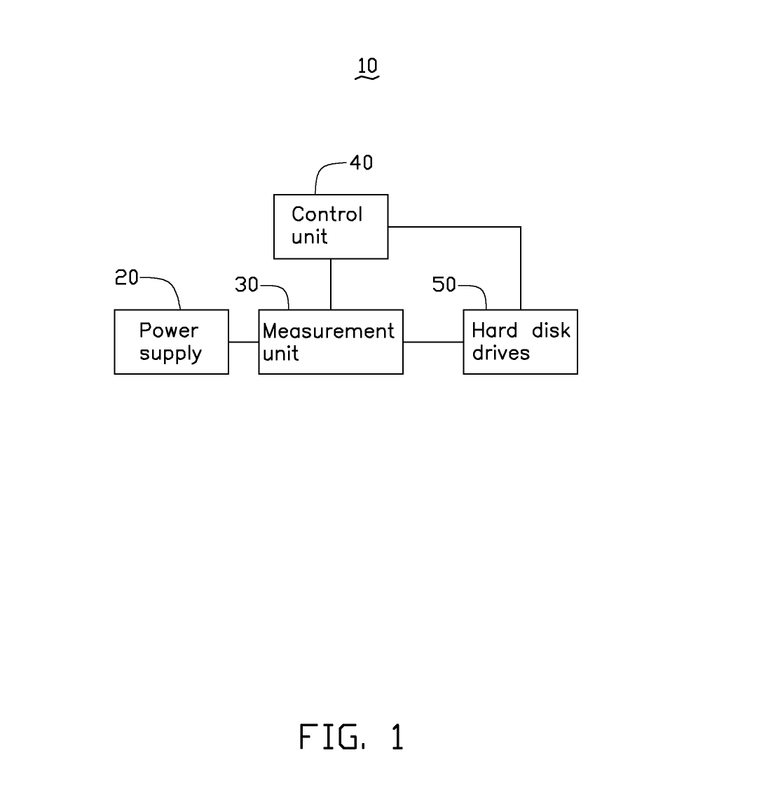

FIG. 1 shows an embodiment of a control circuit 10 of the present disclosure.

The control circuit 10 comprises a power supply 20, a measurement unit 30, a control unit 40, and a plurality of hard disk drives 50.

The power supply 20 is connected to the hard disk drives 50 through the measurement unit 30. The measurement unit 30 is also connected to the hard disk drives 50 through the control unit 40.

The power supply 20 supplies power for the hard disk drives 50 through the measurement unit 30. The measurement unit 30 measures an output current of the power supply 20 and compares the output current with a preset current. When the output current of the power supply 20 is less than or equal to the preset current, the hard disk drives 50 are started up normally (i.e., started up at the same time). When the output current of the power supply 20 is greater than the preset current, the measurement unit 30 outputs a trigger signal to the control unit 40, and the control unit 40 outputs a control signal to the hard disk drives 50. When the hard disk drives 50 receive the control signal, the hard disk drives 50 are started up in a predetermined order.

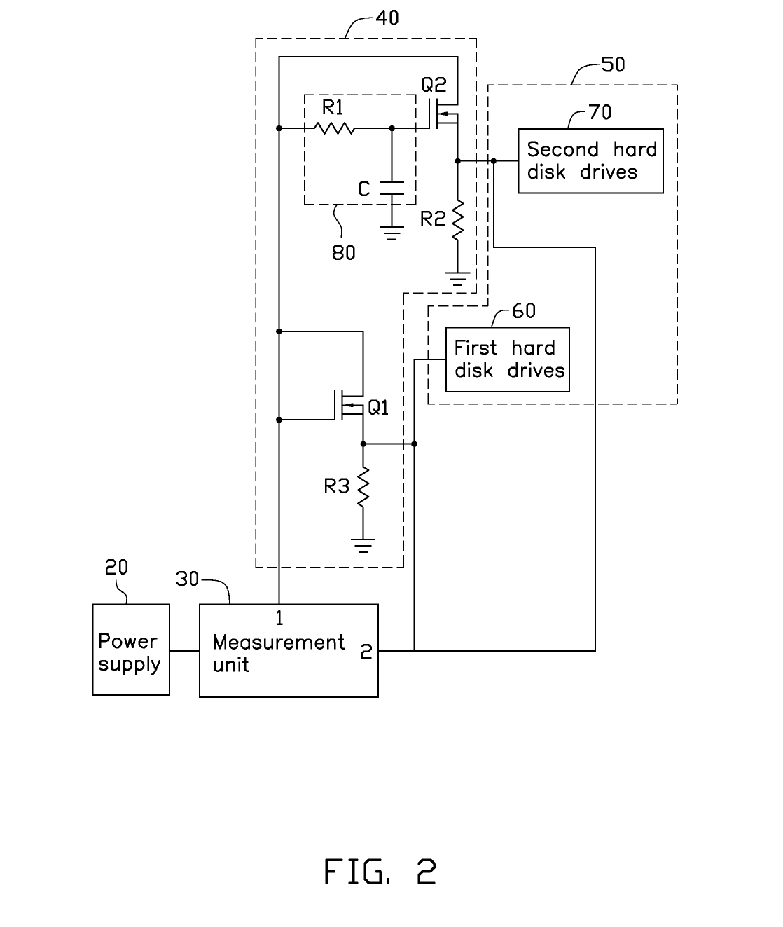

FIG. 2 shows a circuit diagram of the control circuit 10 of FIG. 1.

In one embodiment, the control unit 40 comprises two n-channel metal-oxide-semiconductor field-effect transistors (MOSFETs) Q1 and Q2, and a delay circuit 80, which comprises a resistor R1 and a capacitor C. The hard disk drives 50 comprise a first hard disk drive 60 and a second hard disk drive 70. A gate of the MOSFET Q1 is connected to a first pin 1 of the measurement unit 30. A drain of the MOSFET Q1 is also connected to the first pin 1 of the measurement unit 30. A source of the MOSFET Q1 is grounded through a resistor R3. A node between the resistor R3 and the source of the MOSFET Q1 is connected to a control pin of the first hard disk drive 60. A gate of the MOSFET Q2 is connected to the first pin 1 of the measurement unit 30 through the resistor R1. A node between the resistor R1 and the gate of the MOSFET Q2 is grounded through the capacitor C. A source of the MOSFET Q2 is grounded through a resistor R2. A node between the source of the MOSFET Q2 and the resistor R2 is connected to a control pin of the second hard disk drive 70. A drain of the MOSFET Q2 is connected to the first pin 1 of the measurement unit 30. The control pins of the first and second hard disk drives 60 and 70 are also connected to a second pin 2 of the measurement unit 30.

If the output current of the power supply 20 is less than or equal to the preset current, the measurement unit 30 outputs a low-level signal, such as logic 0, to the gates of the MOSFETs Q1 and Q2 through the first pin 1, to turn off the MOSFETS Q1 and Q2. The measurement unit 30 outputs a high-level signal, such as logic 1, to the control pins of the first and second hard disk drives 60 and 70 through the second pin 2, to start the first and second hard disk drives 60 and 70 normally. Thus, the first and second hard disk drives 60 and 70 are started at the same time. If the output current of the power supply 20 is greater than the preset current, the measurement unit 30 outputs a high level signal to the gate of the MOSFET Q1 through the first pin 1, to turn on the first MOSFET Q1. The high level signal from the first pin 1 is delayed by the delay circuit 80 before being outputted to the gate of the second MOSFET Q2, to turn on the second MOSFET Q2. Thus, the first hard disk drive 60 is started up before the second hard disk drive 70.

While the disclosure has been described by way of embodiments, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A control circuit for a plurality of hard disk drives, comprising:
a power supply supplying power;
a measurement unit to measure a current of the power supply and output a trigger signal when the current of the power supply is greater than a preset current; and
a control unit connected between the measurement unit and the plurality of hard disk drives, wherein when the control unit receives the trigger signal, the control unit outputs a control signal to control the plurality of hard disk drives to start up in turn.

2. The control circuit of claim 1, wherein when the current of the power supply is less than or equal to the preset current, the plurality of hard disk drives starts up at the same time.

3. The control circuit of claim 1, wherein the plurality of hard disk drives comprises first and second hard disk drives, the control unit comprises first and second metal oxide semiconductor field effect transistors (MOSFETs), a gate of the first MOSFET is connected to a first pin of the measurement unit, a source of the first MOSFET is grounded through a first resistor, a drain of the first MOSFET is connected to the first pin of the measurement unit, a node between the first resistor and the source of the first MOSFET is connected to a control pin of the first hard disk drive, a gate of the second MOSFET is connected to the first pin of the measurement unit through a delay circuit, a drain of the second MOSFET is connected to the first pin of the measurement unit, a source of the second MOSFET is grounded through a second resistor, a node between the second resistor and the source of the second MOSFET is connected to a control pin of the second hard disk drive, and a second pin of the measurement unit is connected to the control pins of the first and second hard disk drives.

4. The control circuit of claim 3, wherein the first and second MOSFETs are n-channel MOSFETs.

5. The control circuit of claim 4, wherein the first MOSFET is turned on at a first time, and the second MOSFET is turned on at a second time, in response to the first pin of the measurement unit outputting a high level signal, the second time being later than the first time because of the delay circuit.

6. The control circuit of claim 3, wherein the delay circuit comprises a third resistor and a capacitor, the gate of the second MOSFET is connected to the first pin of the measurement unit through the third resistor, and a node between the third resistor and the gate of the second MOSFET is grounded through the capacitor.
